(19) United States
(12) Patent Application Publication
(10) Pub. No.: US 2014/0251907 A1
(43) Pub. Date: Sep. 11, 2014

(54) METHOD FOR SEPARATING RADIOACTIVE NUCLIDES BY MEANS OF CERAMIC FILTER MEMBRANES

(71) Applicants: Kay Gabriel, Jeddah (SA); Christof Gränitz, Wahlschied (DE); Martin Kaschek, St. Ingbert (DE); Olaf Binkle, Kirkel (DE)

(72) Inventors: Kay Gabriel, Jeddah (SA); Christof Gränitz, Wahlschied (DE); Martin Kaschek, St. Ingbert (DE); Olaf Binkle, Kirkel (DE)

(73) Assignee: ItN Nanovation AG, Saarbrücken (DE)

(21) Appl. No.: 14/343,095

(22) PCT Filed: Aug. 22, 2012
(86) PCT No.: PCT/EP2012/066367

§ 371 Date: May 12, 2014

(30) Foreign Application Priority Data
Sep. 7, 2011 (DE) 102011082285.2

(51) Int. Cl. C02F 9/00; C02F 1/44; C02F 1/58; C02F 1/72

(52) U.S. Cl. CPC C02F 9/00; C02F 1/72; C02F 1/441; C02F 1/58
USPC 210/638; 210/758; 210/206; 210/202; 210/763

(57) ABSTRACT

A method of obtaining industrial water or drinking water from water that contains radioactive nuclides, in radium-containing groundwater including chemically pretreating the radioactive nuclide-containing water, and filtering the chemically pretreated water, wherein, in the chemical pretreatment, manganese dioxide is added to the water and/or manganese dioxide is generated in situ in the water and wherein filtration of the chemically pretreated water proceeds using at least one ceramic filter membrane.

### TECHNICAL FIELD

This disclosure relates to a method of obtaining industrial water or drinking water from water that contains radioactive nuclides.

### BACKGROUND

Water is a precious commodity in many countries, for instance in numerous African and Arabian countries in which complex measures must be taken to cover the need for drinking water and industrial water. In Saudi Arabia, for example, considerable amounts of water are extracted from deep wells or provided via seawater desalination plants. A problem, however, is that water from deep wells frequently contains very high fractions of radioactive nuclides and heavy metal salts such as iron and manganese salts. In water from deep wells, in particular the isotopes ²²⁶Ra and ²²⁸Ra are found, and also ²²⁸Th which is bound to the same decay chain. These are formed, in particular, by the decay of naturally occurring uranium. In deep groundwater, the radioactive nuclides are generally either in the form of dissolved ions or are bound to fine suspended mineral matter.

Deep groundwater is usually purified using reverse osmosis methods, via which the majority of the ionic loading present in the water can be separated off. In order that the reverse osmosis membranes in use are not too severely polluted, usually a plurality of prepurification steps are connected upstream of the reverse osmosis. These are, in particular, filtration steps in which the mentioned suspended particles present in the water and precipitated heavy metal compounds and the radioactive nuclides bound thereto are intended to be separated off. In Saudi Arabia, for this purpose, sand filters weighing tons have been used to date. Such sand filters have diverse disadvantages. They do not achieve their full capacity directly after starting up, but instead they must first be run in with great effort. After some months (generally up to a maximum of 20 months), high amounts of radioactive nuclides have become fixed in the sand filters regularly such that the filters must be replaced. Re-geeration of the filters is not practicable, disposal thereof is problematic solely because of the extremely large amounts of contaminated sand.

The radium ions or thorium ions contained in the deep groundwater are separated off only inadequately by a sand filter alone. Attempts are therefore made to precipitate out the ions chemically, before the deep groundwater enters into the sand filter. The radioactive precipitate thus produced can then be retained in the sand filter. The most useful variant of the precipitation is the addition of water-soluble barium salts, for example, barium chloride. Generally, the deep groundwaters that are to be purified also contain sulphate ions. As a result, therefore, for example, the radium present in the water can precipitate out after addition of the barium chloride as Ba(Ra)SO₄.

Corresponding procedures may be found, for example, in U.S. Pat. No. 4,636,367, U.S. Pat. No. 4,423,007 and U.S. Pat. No. 4,265,861. However, it is disadvantageous that, e.g., barium chloride is toxic and very expensive. In addition, barium ions, in the event of incomplete precipitation, can be carried over to downstream reverse osmosis appliances. High concentrations of barium ions can lead to damage of the reverse osmosis membranes arranged in the appliances.

It could therefore be helpful to markedly improve the long-practiced procedures of removing radioactive nuclides from deep groundwaters.

### SUMMARY

We provide a method of obtaining industrial water or drinking water from water that contains radioactive nuclides, in radium-containing groundwater, including chemically pretreating of the radioactive nuclide-containing water, and filtering the chemically pretreated water, wherein, in the chemical pretreatment, manganese dioxide is added to the water and/or manganese dioxide is generated in situ in the water and wherein filtration of the chemically pretreated water proceeds using at least one ceramic filter membrane.

We further provide a plant that removes radioactive nuclides from radium-containing groundwater including at least one container for the chemical pretreatment of the radium-containing water, at least one filtration appliance that purifies the chemically pretreated water by filtration; and optionally a device that carries out a pressure-driven membrane separation method to further treat the water purified by filtration, wherein the at least one container for the chemical pretreatment of the radium-containing water is coupled to storage containers from which manganese dioxide or a manganese salt and an oxidizing agent can be fed into the container for the chemical pretreatment, and the filtration appliance is a device comprising at least one ceramic filter membrane.

### BRIEF DESCRIPTION OF THE DRAWINGS

FIG. 1 schematically shows steps of an example of our methods.

### DETAILED DESCRIPTION

Our methods serve to obtain industrial water or drinking water from water that contains radioactive nuclides such as, e.g., the radium and thorium isotopes mentioned at the outset, in particular from radium-containing groundwater. Industrial water, in contrast to drinking water, is not suitable for consumption, but must nevertheless meet defined quality criteria so that it can be used in the private, commercial or agricultural sectors. Radioactivity in this regard is an exclusion criterion; a contamination limit of 10 pCi/l, caused by radioactive nuclides, should not be exceeded. In some cases, the limiting value is only 5 pCi/l.

Our methods always comprise the following treatment steps, namely:
a chemical pretreatment of the radioactive nuclide-containing water, and
filtration of the chemically pretreated water.

The methods are particularly characterized in that in the context of the chemical pretreatment, manganese dioxide is added to the water and/or manganese dioxide is generated in situ in the water and in that the filtration of the chemically pretreated water proceeds using a ceramic membrane. This combination of features has proved to be particularly advantageous, whereupon it will be considered further in more detail.

Of the two variants cited, relating to the addition of manganese dioxide to the radioactive nuclide-containing water, the first is preferred, that is to say the variant according to which the manganese dioxide is added directly to the water that is to be purified.

Manganese dioxide is particularly suitable that is present as porous precipitate having a particularly large internal surface area (specific surface area >350 m²/g, determined in accordance with BET). Since manganese dioxide ages and in the process loses porosity, as far as possible it should not be produced until immediately before addition thereof.

Particularly preferably, for this purpose the manganese dioxide used is obtained by oxidation of an aqueous manganese salt solution set to a pH of 4.5 to 9, in particular 7 to 9. A suitable manganese salt is, for example, manganese sulphate. A suitable oxidizing agent is, for example, potassium permanganate or sodium hypochlorite. It is also possible to adjust the potassium permanganate to be basic, for example, using NaOH and to add the basic potassium permanganate to a slightly acidic manganese sulphate solution. In this manner the stoichiometry of the reaction may be controlled better.

The concentration of manganese dioxide in the water is preferably set to a value of 0.1 to 10 ppm. The optimum value in this case is dependent on the amount of radioactive nuclides present in the water which is to be purified. A great excess of manganese dioxide should be avoided as far as possible, since the manganese dioxide must be separated off again. A slight excess, in contrast, can be advantageous, since in the presence of air, iron and other metal ions present can also be possibly co-adsorbed. However, it is preferred first to separate off the iron, in particular by oxidation, and then to add the manganese dioxide.

Preferably, it is possible that the chemical pretreatment of the radioactive nuclide-containing water does not only comprise the mentioned addition of the manganese dioxide. Thus, particularly preferably, in addition to the manganese dioxide, a barium salt is also used in the pretreatment. As mentioned at the outset, the barium salt can, e.g., promote the precipitation of radium.

Furthermore, the addition of further chemicals or of atmospheric oxygen is also conceivable, for example, to oxidize other metals and metal ions present in the water (e.g. the abovementioned separation of iron by oxidation). In such a measure, generally, also, manganese ions that may also be already present in the water are oxidized. By the oxidation of the manganese ions that are already present in the water, an unwanted excess of manganese dioxide can be produced. This can be avoided by determining the amount of these manganese ions present in the water, and only in dependence thereon establishing the amount of the manganese dioxide that is to be added. The total required amount of manganese dioxide is therefore preferably, first, provided by oxidation of manganese ions already present in the water and, second, by the addition of externally synthesized manganese dioxide.

Particularly preferably, the membrane is a microporous membrane.

The ceramic membrane is particularly preferably a flat membrane plate having internal filtrate outlet channels and an external porous separation layer. Such membranes are described extensively, for example, in DE 10 2006 008 453 A1, the contents of which are hereby incorporated by reference.

It is preferred that membrane plates are used in which the pores of the separation layer have a median diameter of 80 nm to 800 nm, in particular 100 nm to 300 nm.

Particularly preferably, filtration units are used which comprise a plurality of flat membrane plates. Suitable filtration units are described, for example, in DE 10 2006 022 502 A1. Particularly suitable are the filtration units described in WO 2010/015374, which comprise at least two ceramic filter membranes. The contents of WO 2010/015374 A1 are hereby incorporated by reference.

The ceramic filter membrane used is preferably operated at a reduced pressure (100 mbar to 600 mbar reduced pressure are preferred), but variants are also possible in which the ceramic filter membranes are operated at a superatmospheric pressure.

As already mentioned above, in particular,. the combination of the addition of manganese dioxide to the radioactive nuclide-containing water and the subsequent filtration using a ceramic filter membrane has proved to be particularly advantageous. With a ceramic filter membrane, the actual separation process takes place exclusively at the surface of the membrane, for which reason a special separation layer is frequently also provided as mentioned above. A problem in this case is, however, that the membrane pores situated at the surface can become blocked very rapidly. In practice, although attempts are made to counteract this by regular backwashing, it is not possible to prevent a layer of separated particles and materials from being deposited on the membrane surface, which layer is constantly becoming thicker during use. For this reason, it was not considered to be possible to replace the sand filters that weigh tons described at the outset by substantially more compact ceramic membranes. Sand filters, in contrast to ceramic membranes, do not have pores that can become blocked, in fact they consist only of a bed of fine sand particles and therefore do not become blocked so readily.

This problem is able to be countered by using the manganese dioxide mentioned in the chemical pretreatment step to separate off radioactive nuclides. Manganese dioxide is itself porous, in particular if it was produced under the abovementioned conditions. For example, radium ions present in the water that is to be purified can be attached by adsorption in the pores of the added manganese dioxide or on the outer surface thereof. The manganese dioxide is then separated off from the ceramic filter membrane together with these attached ions. Owing to its high inherent porosity, the manganese dioxide layer forming on the surface of the ceramic membrane, however, is more permeable than layers of non-porous substances, and so the ceramic membranes lose efficiency less rapidly and backwashing processes are required less often. A constant high flux results without the ceramic membrane becoming blocked.

Owing to the combination of the manganese dioxide addition and the use of a ceramic membrane, frequently results are achieved that are so good that frequently the downstream purification by reverse osmosis that is necessary when sand filters are used can be dispensed with.

Regardless of the above, it can be preferred that, after filtration of the chemically pretreated water, the filtrate is further purified using at least one pressure-driven membrane separation method, wherein the pressure-driven membrane separation method is preferably a reverse osmosis. In addition, for example nanofiltration or ultrafiltration can supplement or replace the reverse osmosis.

It is also possible to mix the water that has been purified by the at least one pressure-driven membrane separation method with water that exits directly from the ceramic membrane.

Our methods have striking advantages compared to the conventional procedures described at the outset. First, the ceramic membranes are substantially more compact than the classical sand filters and usually have a markedly higher flux. Second, the problem that generally occurs of the contaminated sand filters that are to be disposed of is avoided. Only comparatively small amounts of contaminated manganese dioxide slurries arise, which can be simply disposed of, or optionally even recycled. The filtration using ceramic membranes delivers directly from the start a filtrate without suspended matter and separates off radioactive nuclides, in particular radium, more effectively. The sand filters can only achieve such a quality, if at all, after some weeks by enrichment effects. In addition, in the case of the sand filters, on backwashing, again MnO₂ and radioactive nuclides are carried over into the filtrate.

Our plants that remove radioactive nuclides from water, in particular from radium-containing groundwater, comprise:
at least one container for the chemical pretreatment of the radioactive nuclide-containing water, and
at least one filtration appliance in order to purify the chemically pretreated water by filtration.

Optionally, they can also comprise a device for carrying out a pressure-driven membrane separation method for further treatment of the water purified by filtration.

In this case, the at least one container for the chemical pretreatment of the radium-containing water is coupled to storage containers from which manganese dioxide or a manganese salt and an oxidizing agent (which must be able to oxidize the manganese salt to manganese dioxide) can be fed into the container for the chemical pretreatment. The filtration appliance is a device comprising at least one ceramic filter membrane.

Containers suitable for treating radium-containing water chemically are known and need not be described in more detail. The same applies to devices for carrying out pressure-driven membrane separation methods.

With respect to suitable devices comprising the at least one ceramic filter membrane, reference is made to the abovementioned DE 10 2006 022 502 A1 and WO 2010/015374.

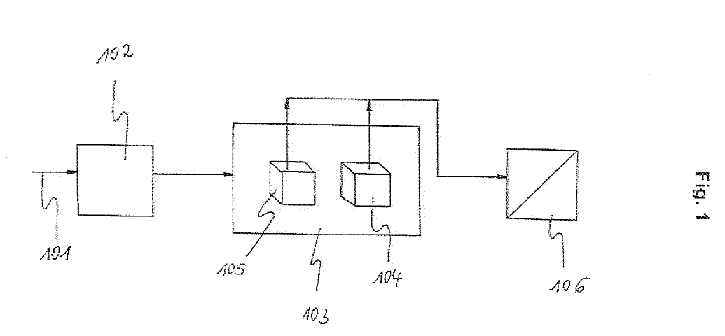

In FIG. 1, the fundamentals of the method sequence are shown schematically for a preferred example of our method. A raw water stream 101 enters into the containers for the chemical pretreatment 102. Therein, the raw water is first admixed with atmospheric oxygen and the disinfectant chlorine or sodium hypochlorite (e.g. respectively 0.1 to 4 ppm free chlorine), then a manganese dioxide suspension is fed in. After an exposure time, the water ad-mixed with manganese dioxide can be transferred to the filtration tank 103. Therein, two filtration appliances 104 and 105 are arranged, each of which comprises a plurality of ceramic filter membranes having internal filtrate outlet channels. Here, the manganese dioxide is separated off. The resultant filtrate is then introduced into the reverse osmosis unit 106 and is then purified there. As stated above, however, this is not absolutely necessary.

Obviously, it is possible that the method, in addition to the treatment steps shown in FIG. 1, comprises further purification steps. It can be advantageous, for example, to provide in addition multimedia filters or ion exchangers, in each case dependent on the quality of the water that is to be purified.

1.-7. (canceled)

8. A method of obtaining industrial water or drinking water from water that contains radioactive nuclides, in radium-containing groundwater comprising:
chemically pretreating the radioactive nuclide-containing water, and
filtering the chemically pretreated water,
wherein, in the chemical pretreatment, manganese dioxide is added to the water and/or manganese dioxide is generated in situ in the water and wherein filtration of the chemically pretreated water proceeds using at least one ceramic filter membrane.

9. The method according to claim 8, wherein the manganese dioxide is obtained by oxidation of an aqueous manganese salt solution set to a pH of 4.5 to 9 before it is added to the water.

10. The method according to claim 8, wherein the concentration of manganese dioxide in the radium-containing water is set to 0.1 ppm to 10 ppm.

11. The method according to claim 8, wherein the radioactive nuclide-containing water is additionally admixed with a water-soluble barium salt in the pretreatment step.

12. The method according to claim 8, wherein the ceramic filter membrane is a flat membrane plate having internal filtrate outlet channels and an external porous separation layer, and pores of the separation layer have a median diameter of 80 nm to 800 nm.

13. The method according claim 8, wherein, after filtration of the chemically pretreated water, the filtrate is purified using at least one pressure-driven membrane separation method, and the pressure-driven membrane separation method is a reverse osmosis.

14. A plant that removes radioactive nuclides from radium-containing groundwater comprising:
at least one container for the chemical pretreatment of the radium-containing water,
at least one filtration appliance that purifies the chemically pretreated water by filtration; and optionally
a device that carries out a pressure-driven membrane separation method to further treat the water purified by filtration,
wherein the at least one container for the chemical pretreatment of the radium-containing water is coupled to storage containers from which manganese dioxide or a manganese salt and an oxidizing agent can be fed into the container for the chemical pretreatment, and the filtration appliance is a device comprising at least one ceramic filter membrane.

15. The method according to claim 9, wherein the concentration of manganese dioxide in the radium-containing water is set to 0.1 ppm to 10 ppm.

16. The method according to claim 9, characterized in that the radioactive nuclide-containing water is additionally admixed with a water-soluble barium salt in the pretreatment step.

17. The method according to claim 10, characterized in that the radioactive nuclide-containing water is additionally admixed with a water-soluble barium salt in the pretreatment step.

18. The method according to claim 9, wherein the ceramic filter membrane is a flat membrane plate having internal filtrate outlet channels and an external porous separation layer, and pores of the separation layer have a median diameter of 80 nm to 800 nm.

19. The method according to claim 10, wherein the ceramic filter membrane is a flat membrane plate having internal filtrate outlet channels and an external porous separation layer, and pores of the separation layer have a median diameter of 80 nm to 800 nm.

20. The method according to claim 11, wherein the ceramic filter membrane is a flat membrane plate having internal filtrate outlet channels and an external porous separation layer, and pores of the separation layer have a median diameter of 80 nm to 800 nm.

21. The method according claim 9, wherein, after filtration of the chemically pretreated water, the filtrate is purified using at least one pressure-driven membrane separation method, and the pressure-driven membrane separation method is a reverse osmosis.

22. The method according claim 10, wherein, after filtration of the chemically pretreated water, the filtrate is purified using at least one pressure-driven membrane separation method, and the pressure-driven membrane separation method is a reverse osmosis.

23. The method according claim 11, wherein, after filtration of the chemically pretreated water, the filtrate is purified using at least one pressure-driven membrane separation method, and the pressure-driven membrane separation method is a reverse osmosis.

24. The method according claim 12, wherein, after filtration of the chemically pretreated water, the filtrate is purified using at least one pressure-driven membrane separation method, and the pressure-driven membrane separation method is a reverse osmosis.
